(19) United States
(12) Patent Application Publication
(10) Pub. No.: US 2016/0206489 A1
(43) Pub. Date: Jul. 21, 2016

(54) ADJUSTABLE BED WITH MAGNETIC MATTRESS MOUNT

(71) Applicant: ASCION, LLC D/B/A REVERIE, Bloomfield Hills, MI (US)

(72) Inventors: Martin B. Rawls-Meehan, Franklin, MI (US); Andrew Z. Gong, Waterford, MI (US); Kyle Allen Nagelkirk, Waterford Township, MI (US); Christopher D. Williams, Bloomfield Hills, MI (US)

(21) Appl. No.: 14/994,611

(22) Filed: Jan. 13, 2016

Related U.S. Application Data
(60) Provisional application No. 62/104,353, filed on Jan. 16, 2015.

(51) Int. Cl. A61G 7/015

(52) U.S. Cl. CPC A61G 7/015

(57) ABSTRACT

The disclosure generally relates to an adjustable bed, in particular incorporating a magnetic mattress mount. In various embodiments, an adjustable bed foundation and a mattress of an adjustable bed each can include magnetic materials placed in complementary positions relative to each other. The magnetic materials maintain the mattress in a desired position and alignment with respect to the adjustable bed foundation, in particular when adjustable bed foundation is adjusted between various articulated positions (e.g., flat, inclined, and/or declined).

### CROSS REFERENCE TO RELATED APPLICATION

Priority is claimed to U.S. Provisional Application No. 62/104,353 (filed Jan. 16, 2015), which is incorporated herein by reference in its entirety.

### STATEMENT OF GOVERNMENT INTEREST

None.

### BACKGROUND OF THE DISCLOSURE

### Field of the Disclosure

The disclosure generally relates to an adjustable bed, in particular incorporating a magnetic mattress mount. In various embodiments, an adjustable bed foundation and a mattress of an adjustable bed each can include magnetic materials placed in complementary positions relative to each other. The magnetic materials maintain the mattress in a desired position and alignment with respect to the adjustable bed foundation, in particular when adjustable bed foundation is adjusted between various articulated positions (e.g., flat, inclined, and/or declined).

Shih U.S. Publication No. 2013/0042412 is directed to an adjustable bed having a stably mounted mattress. The adjustable bed includes a base platform, a mattress on the base platform, a first magnetic member provided at the base platform, and a second magnetic member provided at the mattress.

### SUMMARY

In one aspect, the disclosure relates to an adjustable bed comprising: (a) a mattress support surface comprising (i) a first deck support section, (ii) a second deck support section pivotally attached to the first deck support section, (iii) optionally a third deck support section pivotally attached to the second deck support section, and (iv) optionally a fourth deck support section pivotally attached to the third deck support section; (b) a mattress positioned above the mattress support surface; (c) a first deck magnetic material disposed on an upper surface of the mattress support surface; and (d) a first mattress magnetic material disposed on an outer bottom surface of the mattress and positioned in a complementary position relative to the first deck magnetic material; wherein at least one of the first deck magnetic material and the first mattress magnetic material exerts a magnetic force attracting the complementary magnetic material. In some embodiments, the disclosure relates to an adjustable foundation including the mattress support surface and the first deck magnetic material as above (e.g., without the mattress and the first mattress magnetic material, which may be provided separately and placed on the adjustable foundation by a user).

Various refinements of the adjustable bed and foundation are possible. In a refinement the first deck magnetic material and the first mattress magnetic material are in contact with each other. In another refinement, at least one of the first deck magnetic material and the first mattress magnetic material is at least partially enclosed (e.g., completely enclosed) in a sleeve or pouch mounted on at least one of the mattress support surface and the mattress, respectively. For example, the sleeve can comprise an open area exposing its partially enclosed magnetic material to the opposing corresponding magnetic material or sleeve enclosing the opposing corresponding magnetic material. For example, the sleeve can further comprise a high-friction material disposed on an outer surface of the sleeve and opposing the corresponding magnetic material. In another refinement, the first deck magnetic material is at least partially enclosed in a first sleeve mounted on the mattress support surface, and the first mattress magnetic material is at least partially enclosed in a second sleeve mounted on the mattress. In another refinement, the first deck magnetic material laterally extends a substantial portion of the mattress support surface width, and the first mattress magnetic material laterally extends a substantial portion of the mattress width. For example, the first deck magnetic material can laterally extend at least 40% of the mattress support surface width, and the first mattress magnetic material can laterally extend at least 40% of the mattress width. In another refinement, (i) the first deck magnetic material is disposed on an upper surface of the first deck section of the mattress support; (ii) the first deck section corresponds to a foot portion of the mattress support surface and the mattress; and (iii) deck support sections of the mattress support other than the first deck section are free from magnetic materials disposed thereon. In another refinement, (i) the first deck magnetic material is disposed on an upper surface of the first deck section of the mattress support; (ii) the first deck section corresponds to a foot portion of the mattress support surface and the mattress; and (iii) deck support sections of the mattress support corresponding to a head portion of the mattress support surface and the mattress are free from magnetic materials disposed thereon. In another refinement, both of the first deck magnetic material and the first mattress magnetic material exert an attractive magnetic force toward each other. In another refinement, the coefficient of static friction (μₛ) at a contact interface between the first deck magnetic material and the first mattress magnetic material is at least 0.5. In another refinement, at least one of the first deck magnetic material and the first mattress magnetic material comprises a polymer material selected from the group consisting of a thermoset elastomer and a thermoplastic elastomer. In another refinement, at least one of the first deck magnetic material and the first mattress magnetic material comprises a sheet magnet material. In another refinement, both of the first deck magnetic material and the first mattress magnetic material comprises a sheet magnet material. In another refinement, both of the first deck magnetic material and the first mattress magnetic material comprises an isotropic sheet magnet material. In another refinement, the magnetic material exerting a magnetic force exerts at least 100 lb_{f} normal pulling force.

In another aspect, the disclosure relates to method for adjusting an adjustable bed, the method comprising: (a) providing an adjustable bed according to any of its disclosed embodiments; and (b) articulating the adjustable bed from a first position to a second position, wherein: (i) the mattress support surface in the second position is other than a flat configuration; and (ii) the mattress remains substantially in contact with the mattress support surface in the first position and the second position.

Additional features of the disclosure may become apparent to those skilled in the art from a review of the following detailed description, taken in conjunction with the drawings, examples, and appended claims.

### BRIEF DESCRIPTION OF THE DRAWINGS

For a more complete understanding of the disclosure, reference should be made to the following detailed description and accompanying drawings wherein:

FIG. 1 is a side view of an adjustable bed including an adjustable foundation and a magnetically mounted mattress according to the disclosure.

FIG. 2 is a top perspective illustration of a mattress according to the disclosure.

FIG. 3 includes a top view (A) of an adjustable foundation and a bottom view (B) of a mattress including magnetic mounting materials according to the disclosure.

FIGS. 4A-4C are front cross-sectional views of a pouch-mounted magnetic material on an outer surface of a mattress according to the disclosure.

While the disclosed apparatus and methods and are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### DETAILED DESCRIPTION

The disclosure generally relates to an adjustable bed, in particular incorporating a magnetic mattress mount. In various embodiments, an adjustable bed foundation and a mattress of an adjustable bed each can include magnetic materials placed in complementary positions relative to each other such that they provide an attractive magnetic (normal) force toward each other. The magnetic materials, which are suitably located in the a foot region of the adjustable bed, maintain the mattress in a desired position and alignment with respect to the adjustable bed foundation, in particular when adjustable bed foundation is adjusted between various articulated positions (e.g., flat, inclined, and/or declined). The magnetic materials provide a non-invasive mounting means that can be incorporated onto an outer surface of essentially any mattress (e.g., conventional mattress, foam-based mattress such as including foam cylinders), and they can be used as an alternative to mechanical mattress mounting/stabilizing structures (e.g., frame/mattress mounting brackets and the like, which can be also included in or completely absent from the adjustable bed). In some embodiments, a sleeve or pouch can be sewn, stitched, or otherwise attached to the outer mattress surface as a non-invasive means to mount the magnetic materials to the mattress. Thus, the magnetic materials can be added to any existing mattress without a need to open the mattress or otherwise internally insert the magnetic materials into the mattress, a procedure to which mattress manufacturers are resistant.

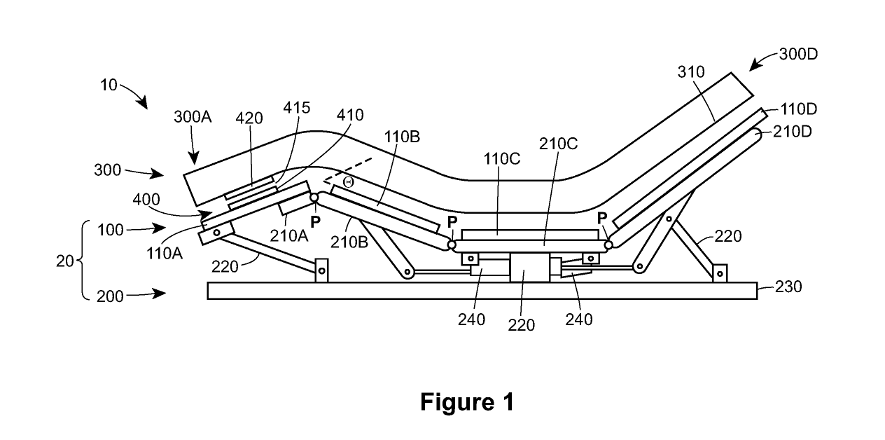

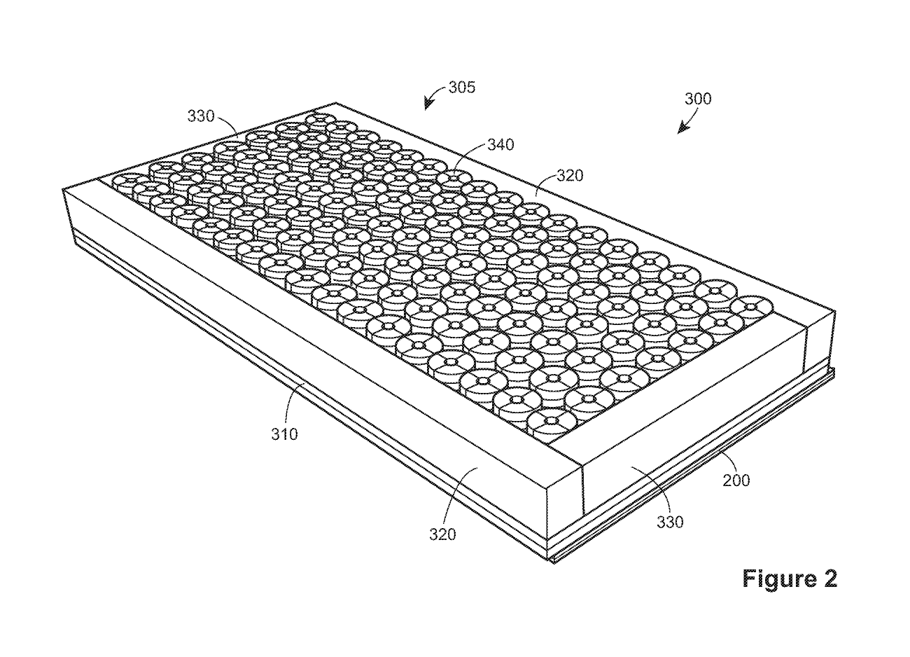

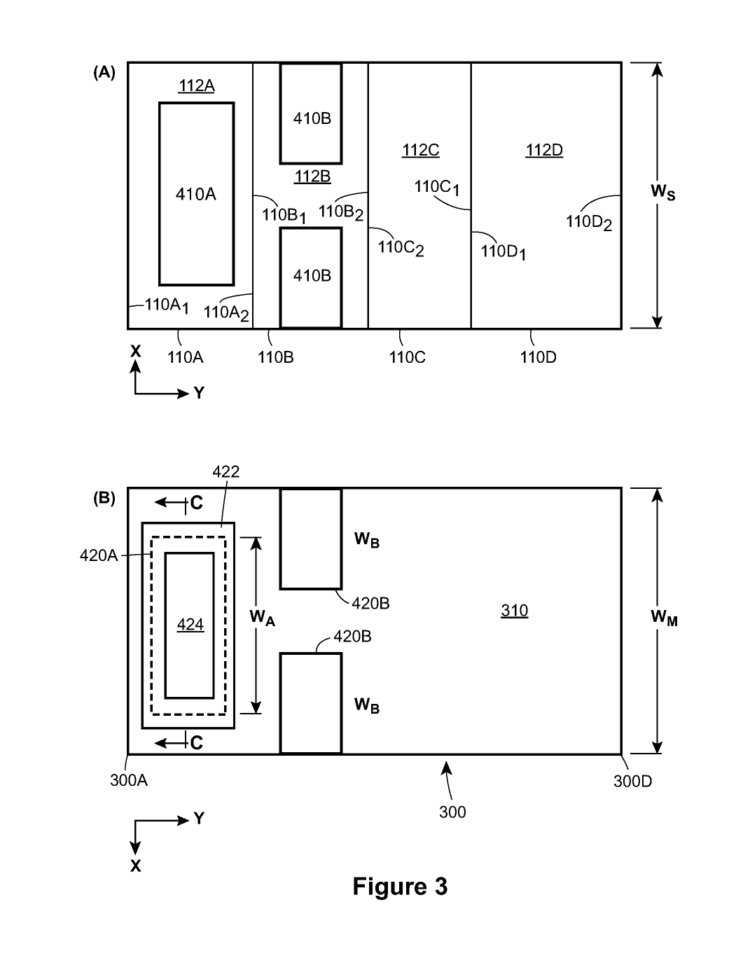

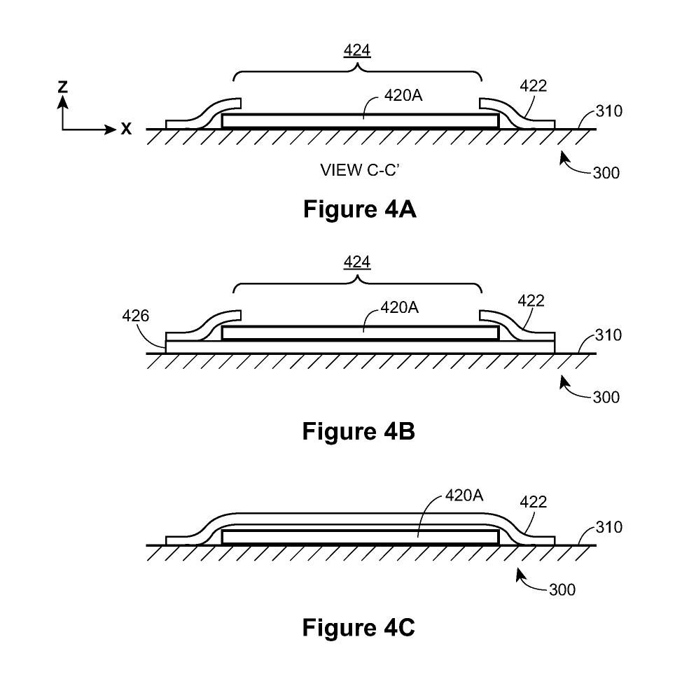

FIG. 1 is a side view of an adjustable bed 10 according to the disclosure. The illustrated adjustable bed 10 includes an adjustable foundation 20 (e.g., adjustable bed foundation), a mattress 300 sitting atop the adjustable foundation 20, and a magnet mattress alignment system 400 (e.g., including pairs of magnets 410, 420 positioned at one or more locations on the foundation 20 and the mattress 300). The adjustable foundation 20 can include a mattress support (or deck) 100 mounted to an adjustable frame 200. FIG. 2 is a top perspective illustration of a mattress 300 according to the disclosure. FIG. 3 includes a top view (A) the an adjustable foundation 20 and a bottom view (B) of the mattress 300 including magnetic mounting materials 410, 420 according to the disclosure. FIGS. 4A-4C are front cross-sectional views of a pouch-mounted magnetic material 420 on an outer surface of a mattress 300 according to the disclosure.

The mattress support 100 includes a deck support 110 platform, for example including a plurality of deck support sections 110A-110D as illustrated. A deck support platform 110 formed from a plurality of deck support sections 110A-110D, each having a corresponding upper surface 112A-112D (i.e., the surface which supports the mattress 300) is suitable for the adjustable foundation 20. In the illustrated embodiment, section 110A corresponds to the foot portion of the bed, section 110B corresponds to the leg portion of the bed, section 110C corresponds to the bottom portion of the bed, and section 110D corresponds to the head and neck portion of the bed 10 (i.e., where the sections correspond to the body portion of a user laying on the bed 10/mattress 300 in a normal use orientation). Each section 110A-110D includes longitudinally opposed ends 110A₁ and 110A₂, 110B₁ and 110B₂, 110C₁ and 110C₂, 110D₁ and 110D₂, respectively, where the longitudinal direction Y is generally defined as being perpendicular to the pivot axis P (described below) and/or along the mattress support 100 length or mattress 300 length. Each deck support section 110A-110D can be pivotally attached to one or more adjacent sections (e.g., directly or indirectly via underlying frame 200 structure as described below), thus allowing each section 110A-110D to rotate independently around the lateral pivot axis P (e.g., an axis generally in the lateral direction X and perpendicular to the longitudinal direction Y). The mattress support 100 generally includes at least two deck support sections, for example including a first (foot) support section 110A, a second (leg) support section 110B pivotally attached to the first section 110A, a third (bottom) support section 110C pivotally attached to the second section 110B, and a fourth (head/neck) support section 110D pivotally attached to the third section 110C as shown in FIG. 1. In other embodiments (not shown), the mattress support 100 can have fewer or more support sections (e.g., a first (foot) support section, a second (leg and bottom) support section pivotally attached thereto, and a third (head/neck) support section pivotally attached thereto). In some embodiments the support sections 110A-110D can be formed from a rigid support material such as wood or metal. In other embodiments the support sections 110A-110D can be formed from a flexible fabric or padding material (e.g., alone or in combination with a rigid support material, such as a cover or padding for an underlying rigid support material).

The adjustable frame 200 generally provides the mechanical, electrical, and electronic support and articulation components for the adjustable foundation 20 and bed 10. As illustrated, the adjustable frame 200 includes a frame support 210, for example including a plurality of frame support sections 210A-210D as illustrated and corresponding to the deck support sections 110A-110D. Each deck support section 110A-110D can be fixedly or removably mounted (e.g., via bolts, screws, or other fastener or adhesive components) to its underlying frame support section 210A-210D such that when one or more frame support sections 210A-210D are articulated, the deck support sections 110A-110D are correspondingly articulated. As illustrated, each frame support section 210A-210D can be pivotally attached at a pivot axis P to one or more adjacent sections (e.g., directly as illustrated and providing an indirect pivotal attachment for corresponding deck support sections), thus allowing each section 210A-210D to rotate independently around the lateral pivot axis P. The adjustable frame 200 generally includes at least two frame support sections, for example including a first (foot) support section 210A, a second (leg) support section 210B pivotally attached to the first section 210A, a third (bottom) support section 210C pivotally attached to the second section 210B, and a fourth (head/neck) support section 210D pivotally attached to the third section 210C as shown in FIG. 1. In other embodiments (not shown), the adjustable frame 200 can have fewer or more frame support sections (e.g., a first (foot) support section, a second (leg and bottom) support section pivotally attached thereto, and a third (head/neck) support section pivotally attached thereto).

As illustrated, the adjustable frame 200 further includes a subframe 230, for example a rigid, non-articulatable frame structure which sits on a floor or within a decorative bed frame common in the furniture industry such as a platform bed (e.g., via various leg elements, not shown) and provides stability for the bed foundation 20 as the adjustable frame 200 is articulated to various different positions. The adjustable frame 200 can further include one or more support members 220 connecting structure between the subframe 230 and the frame support 210 and sections 210A-210D thereof. In some embodiments, one or more of the frame sections 210A-210D can be fixed in position relative to the subframe 230 (e.g., bottom section 210C as illustrated) and be unable to rotate or articulate relative to the subframe 230, although other frame sections pivotally attached thereto are able to rotate or articulate. As further illustrated, the adjustable frame 200 can include one or more actuators 240 variously mounted to one or more of the subframe 230, a support member 220, and a frame support section 210A-210D. In some embodiments, the subframe 230, the support members 220, and the frame support sections 210A-210D can be formed from metal such as steel. The actuators 240 can be any of those commonly known in the art. The actuators 240 and, correspondingly, the configuration or position of the adjustable frame 200, mattress support 100, and mattress 300 can be controlled and adjusted by a suitable power supply (not shown), adjustable bed controller (not shown; e.g., programmable logic controller or otherwise), and remote control to deliver repositioning commands (not shown).

The mattress 300 is not particularly limited, and it can be a conventional mattress 300 (e.g., a spring or coil mattress, memory foam mattress, air mattress) with a base 310 (e.g., a continuous fabric material) suitable for use on a mattress support structure such as a fixed bed frame or an adjustable bed frame. In the illustrated embodiment, the mattress 300 includes a mattress containment frame 305 including a plurality of foam cells (or foam springs) 340 positioned in the frame 305 to provide the sleeping support surface for the mattress. The mattress containment frame 305 includes a lower/bottom base 310, sidewalls 320, and endwalls 330 which generally define the interior frame 305 volume housing the foam cells 340. The sidewalls 320 and endwalls 330 suitably are formed from a foam material. The base 310 can be a generally continuous fabric material. The mattress 300 is generally positioned above the mattress support 100 surface 112, for example sitting directly atop the deck support sections 110A-110D. In other embodiments, other structure between the mattress 300 and mattress support 100 surface 112 can be present, for example a padding or cushion material (e.g., which can be continuous or include openings where corresponding magnetic materials 410, 420 are positioned on the mattress 300 and mattress support 100.

The magnet mattress alignment system 400 generally includes a first deck magnetic material 410 located on an upper surface 112 of the mattress support 100 and a first mattress magnetic material 420 located on an outer bottom surface 310 of the mattress 300 and positioned in a complementary position to the first deck magnetic material 410 (e.g., magnetic materials 410, 420 having generally overlapping areas, although they need not have the exact same surface areas or contact areas). For each pair of complementary magnetic materials in the alignment system (e.g., magnetic materials 410, 420 as shown), at least one of the two magnetic materials exerts an attractive magnetic force towards the opposing magnetic material (e.g., in a normal direction Z perpendicular to the local longitudinal direction Y and the local lateral direction X of the surface to which the magnetic material is mounted). For example, in some embodiments, one magnetic material 410 or 420 can be a magnet exerting the attractive magnetic force, and the opposing magnetic material 410 or 420 can be a magnetizable or magnetically attractable material attracted by the magnetic force (e.g., an iron-containing material or other magnetically attractable magnetic material). In other embodiments, both magnetic materials 410, 420 can be magnets exerting an attractive force to each other. The particular type of magnet exerting the magnetic force is not particularly limited, for example including a permanent magnet (e.g., in a flexible sheet form using a polymeric matrix; in a metallic slab form) or an electromagnet (e.g., magnets requiring a constant flow of electrical current to exert a continuous magnetic force; magnets requiring a pulse of electrical current to activate or deactivate the magnetic force).

In some embodiments, the magnetic materials 410, 420 in a complementary paring can be in contact with each other when the mattress 300 sits atop the mattress support 100. As illustrated in FIG. 3, for example, the deck magnetic material 410A directly contacts the mattress magnetic material 420A, and the deck magnetic materials 410B directly contact the mattress magnetic materials 420B (i.e., when the mattress 300 is on the mattress support 100). As further illustrated, the magnetic materials 410A, 420A each can be a single piece of magnetic material (e.g., centrally located across the width direction), while the magnetic materials 410B, 420B each can include two pieces of magnetic material (e.g., laterally spaced apart and positioned at or near the lateral edge of their respective mounting surface). In some embodiments (not shown), the two-piece (or multi-piece) magnetic materials 410B, 420B can be laterally spaced apart and positioned at or near the lateral edge of the foot support section 110A and/or foot end 300A of the mattress 300 (e.g., and also position at the longitudinal end of the foot support section 110A and mattress 300, such as in the foot corner regions of the mounting surfaces). In other refinements (not shown), the head section 110D and/or head end 300D of the mattress 300 can be free of magnetic materials, include single-piece magnetic materials, or include two-piece (or multi-piece) magnetic materials laterally spaced apart and positioned at or near the lateral edge and/or longitudinal end of the mounting surfaces.

In some embodiments, at least one of the magnetic materials 410, 420 in a complementary paring is at least partially enclosed in a pouch or sleeve 422 mounted on at least one of the mattress support 100 surface 112 and the mattress 300. As illustrated in FIG. 3, the mattress magnetic material 420A is partially enclosed in the sleeve 422 mounted to the outer, bottom surface 310 of the mattress 300. In contrast, the other illustrated magnetic materials 410A, 410B, and 420B are mounted directly (e.g., via an adhesive or mechanical fastener) to their respective mattress support 100 surface 112 or mattress 300 bottom surface 310. In other embodiments (not shown), any or all of the magnetic materials 410A, 410B, and 420B can similarly be at least partially enclosed in sleeves. The sleeve 422 can be open (e.g., closed on three sides or edges and open on one side or edge to allow magnetic material to be inserted/removed easily). In some embodiments, the sleeve 422 can be sealable (e.g., an open sleeve as above, but including a zipper, snaps, buttons, etc. to seal the sleeve along the open side or edge with the magnetic material inside). The sleeve 422 can be formed from any suitable material, such as a fabric or textile material (e.g., such as that used in the construction of the mattress or otherwise). Suitably, the sleeve 422 is sewn, stitched, adhered, or otherwise attached to the outer, bottom surface 310 of the mattress 300 or the mattress support 100 surface 112, and then the magnetic material 410 or 420 can be inserted therein.

In some embodiments, for example as shown in FIG. 3, FIG. 4A, and FIG. 4B, the sleeve 422 can include an open area 424 exposing its partially enclosed magnetic material 420A to the opposing corresponding magnetic material 410A (i.e., as illustrated in FIG. 3) or sleeve enclosing the opposing corresponding magnetic material (not shown). The open area 424 is useful to promote direct contact between the magnetic materials 410A, 420A, thus enhancing frictional forces at a contact surface 415 and increasing the resistance to sliding/shearing motion during adjustable bed 10 articulation. The illustrated open sleeve 422 can be stitched or otherwise adhered to the mattress 300 or support deck 100 surface 310 or 112 around its entire periphery, but be formed from a flexible fabric or material to permit simple insertion and removal of the magnetic material 420A. In some embodiments, the sleeve 422 can be in the form of an open, rectangular piece of fabric or material affixed to the mattress 300 or support deck 100 surface 310 or 112 (e.g., as shown in FIG. 4A). In other embodiments, the sleeve 422 can further include a continuous piece of fabric or material 426 as a base or backing, which is in turn affixed to the mattress 300 or support deck 100 surface 310 or 112 (e.g., as shown in FIG. 4B).

In other embodiments, for example as shown in FIG. 4C, the sleeve 422 completely encloses its magnetic material 420A (e.g., as an open or sealable envelope-type structure). In such cases, the sleeve 422 can include a high-friction material disposed on its outer surface and opposing the corresponding magnetic material to increase resistance to sliding. Suitable high friction materials can generally have a higher coefficient of static friction with the opposing surface as compared to the sleeve material, for example having the coefficient values or materials as described below, in particular including various polymeric materials such as thermoplastic or thermoset elastomeric materials. In embodiments with two opposing sleeves completely enclosing its magnetic material, each sleeve can include the high-friction material.

In some embodiments, the deck magnetic material 410 laterally extends a substantial portion of the mattress support 100 surface 112 width W_{S}, and the mattress magnetic material 420 laterally extends a substantial portion of the mattress 300 width W_{M} (e.g., which can be the same or substantially the same as W_{S}). For example, the deck magnetic material 410 can laterally extend at least 40%, 50%, 60%, 80%, or 90% and/or up 50%, 60%, 80%, 90% or 100% of the width W_{S}, and/or the mattress magnetic material 420 can laterally extend at least 40%, 50%, 60%, 80%, or 90% and/or up 50%, 60%, 80%, 90% or 100% of the width W_{M}. Lateral extension and width are generally defined as parallel to the pivot axis P or, equivalently, perpendicular to the major length direction of the mattress 300 and mattress support 100 (e.g., in the local lateral direction X and perpendicular to the local longitudinal direction Y). Such lateral extension of the magnetic materials 410, 420 creates an additional resistance to off-longitudinal axis Y twisting force or torque applied to the mattress 300 (e.g., when occupants on the mattress 300 create an asymmetric load thereon during bed 10 articulation), this maintaining the mattress 300 properly laterally aligned on the mattress support 100 surface 122, in addition to preventing longitudinal sliding motion. Lateral extent can refer to the total lateral length of the magnetic material, whether present as a single continuous piece of magnetic material or as multiple, spaced-apart pieces of magnetic material. For example, as illustrated in FIG. 3, the magnetic material 420A is a single piece with width W_{A}, so the lateral extent is also W_{A}, and the magnetic material 420A spans a fraction W_{A}/W_{M} of the mattress 300. Similarly, the magnetic material 420B includes two pieces with the same width W_{B} (although they could be different in length), so the lateral extent is 2W_{B}, and the magnetic material 420B spans a fraction 2W_{B}/W_{M} of the mattress 300. For instance, a single 36-inch (91.4 cm) wide magnetic strip can be used to span about 62% of a 58-inch (147 cm) wide queen size mattress or mattress support, and two of the 36-inch (91.4 cm) wide magnetic strips can be used to span about 96% of a 74.8-inch (190 cm) wide king size mattress or mattress support (e.g., in a split-king configuration with two side-by-side twin mattresses (37.4 inch or 95 cm), each with its own laterally aligned magnetic strip). In other embodiments, lateral extent can refer to the lateral distance separating the two furthest magnetic surfaces.

In various embodiments, the magnetic materials 410, 420 are suitably positioned in a foot section of the mattress 300 (e.g., at or near a foot end 300A as opposed to a head end 300D) or in a foot deck support section of the mattress support 100 (e.g., in deck support section 110A). Placement of magnetic materials 410, 420 in the foot regions of the adjustable bed 10 is advantageous because articulation of the foot sections 110A, 210A of the adjustable foundation 20 tends to create shearing forces (e.g., in the local longitudinal direction Y and/or local lateral direction X) between the mattress 300 and the adjustable foundation 20, but minimal or no normal forces (e.g., in the local normal direction Z). The magnetic materials 410, 420 resist the shearing forces and maintain the mattress 300 in proper alignment without vertical/normal separation or lift-off of the mattress 300 from the foundation 20 (e.g., which would prevent the magnetic materials from providing a stabilizing attractive force). In contrast, magnetic materials 410, 420 placed in other regions of the bed 10 might provide less stabilizing effect, for example when bed 10 articulation in the region generates normal or lift-off forces, in particular with a relatively rigid mattress 300 (e.g., a conventional spring or coil mattress). In some embodiments, deck support sections of the mattress support corresponding to a head portion of the mattress support surface and the mattress are free from magnetic materials disposed thereon (e.g., and a corresponding head region of the mattress is also free from magnetic materials). For example, as illustrated in FIG. 3, the deck support section 110D and the corresponding head end 300D of the mattress 300 are free from magnetic materials (e.g., although sections such as the leg section 110B other than the foot section 110A can include magnetic materials). In other embodiments, deck support sections of the mattress support other than the foot deck section are free from magnetic materials disposed thereon (e.g., and only a corresponding foot region of the mattress includes magnetic materials disposed thereon). For example, the magnetic materials 410B, 420B could be removed from the illustrated embodiment of FIG. 3 to include only magnetic materials 410A, 420A in the foot sections of the foundation 20 and the mattress 300.

The magnetic force of the magnet mattress alignment system 400 is sufficient to hold mattress 300 stably in position (e.g., longitudinally and laterally) when the mattress support 110 is articulated between various positions, whether the adjustable bed 10 includes just the mattress 300 alone or an additional normal user occupant load on the mattress 300. For example, the magnetic material(s) exerting a magnetic force exert(s) at least 100 lb_{f}, 150 lb_{f}, 200 lb_{f}, 300 lb_{f}, or 500 lb_{f} and/or up to 200 lb_{f}, 300 lb_{f}, 500 lb_{f}, or 1000 lb_{f} normal pulling force. The normal pulling force corresponding to the magnetically attractive forces can correspond to a total for all magnetic materials exerting a force, whether as a single piece of material or multiple pieces of material located at different locations (e.g., two separate magnet materials attracting separate, corresponding magnetically attractable materials; two separate magnet materials attracting each other).

In some embodiments, the magnetic materials 410, 420 are formed from or otherwise include high-friction materials that prevent or resist sliding or shearing motion when the materials 410, 420 are in contact and exerting an attractive magnetic normal force between them. For example, the coefficient of static friction (μₛ) at a contact interface 415 between the deck magnetic material 410 and the mattress magnetic material 420 can be at least 0.5, 0.6, 0.7, 0.8, 0.9, or 1.0 and/or up to 1.2, 1.5, or 2 (e.g., or even higher for rough surfaces), for example 0.5 to 2, 0.7 to 1.5, 0.8 to 1.2, or 0.9 to 1.1. Such static friction coefficients can represent relatively high-friction polymer-polymer interfaces (e.g., when a polymer is used as a matrix for a permanent magnetic material such as in a sheet magnet) and metal-metal interfaces (e.g., for metallic permanent magnetic materials). Thus, in some embodiments, one or both of the magnetic materials 410, 420 can be sheet magnets, for example isotropic or anisotropic. Suitably, two opposing isotropic sheet magnets are used, thus allowing initial alignment of the mattress 300 on the adjustable foundation 20 by a user without necessarily requiring very precise magnet alignment (e.g., which can be required for anisotropic magnets).

When one or both of the magnetic materials 410, 420 include a polymeric material, the polymer material suitably can be a thermoset elastomer or a thermoplastic elastomer. Generally any thermoset or thermoplastic polymer can be used, in particular those having desirably high friction surface properties. Elastomeric thermoset or thermoplastic polymers can be particularly suitable, as they have a flexible, rubbery nature that can be useful for the flexible bottom surface of a mattress or a magnetic material that spans a pivot point of an otherwise rigid mattress deck. Example thermoset elastomers include natural polyisoprene (natural rubber) or synthetic polyisoprene (synthetic rubber), polybutadiene, chloroprene, butyl rubber, styrene-butadiene, nitrile rubber, ethylene propylene rubber, ethylene propylene diene rubber. Example thermoplastic elastomers include styrenic block copolymers, polyolefin blends, elastomeric alloys, thermoplastic polyurethanes, thermoplastic copolyesters, and thermoplastic polyamides. Both opposing magnetic materials 410, 420 can include polymeric materials, for example as the matrix material for a sheet magnet.

The inclusion of the magnet mattress alignment system 400 into an adjustable bed 10 as generally described herein in any of its variously disclosed embodiments is particularly useful in maintaining the mattress 300 in proper alignment and properly seated on the foundation 20 when the bed 10 is articulated. For example, when articulating the adjustable bed 10 from a first position (e.g., flat or non-flat configuration) to a second position other than a flat configuration (e.g., as illustrated in FIG. 1, for instance), the mattress 300 remains substantially in contact with the mattress support 100 surface 112 in the first position and the second position (e.g., in the first position, in the second position, and while transitioning therebetween). For example, at least 70%, 80%, 90%, 95% and/or up to 80%, 90%, 95%, or 100% of the surface area remains contact between mattress 300 and mattress support 100 surface 122 in the first and second positions (e.g., allowing for some mattress separation from the support surface at the support surface section joints, such where the mattress curves but the support surface can have a sharper transition). The mattress 300 can be characterized by a substantial absence of any lift-off of the mattress 300 from the support 100 surface 112, and the corresponding magnetic materials 410, 420 remain in substantial contact in the first and second positions (e.g., at least 90% or 95% and/or up to 95% or 100% contact surface area remains between the magnetic materials, without lift-off or delamination of the magnetic surfaces). In addition to remaining in substantial contact with the foundation 20, the mattress 300 suitably also remains substantially aligned on its mattress support 100 surface 112 in the first and second positions (e.g., longitudinal axes of the mattress 300 and the support 100 surface 112 are within 1°, 2°, 5°, or 10° of each other).

At least one of the first position and the second position can reflect a high degree of articulation. In an embodiment, at least one deck support section 110A-D is angled at least 10°, 20°, 30°, or 45° and/or up to 20°, 30°, 45°, or 60° relative to an adjacent mattress support surface section in the first or second position (e.g., illustrated as angle Θ in FIG. 1). For example, the angle Θ can represent the degree of articulation between the foot section 110A and an adjacent section such as the leg section 110B (or bottom section depending on structure of adjustable frame), the angle Θ can represent the degree of articulation between the head and/or back section 110D and an adjacent section such as the bottom section 110C (e.g., depending on structure of adjustable frame), as well as multiple combinations of adjacent mattress support sections.

Rawls-Meehan U.S. Pat. Nos. 7,321,811, 7,465,280, 7,805,785, 7,930,783, 7,933,669, 7,979,169, 8,019,486, 8,032,263, 8,032,960, 8,046,114, 8,046,115, 8,046,116, 8,046,117, 8,050,805, 8,069,512, 8,078,336, 8,078,337, 8,150,562, 8,375,488, 8,565,934, and 8,682,457 as well as Rawls-Meehan U.S. Publication No. 2012/0057685 are incorporated herein by reference in their entireties and variously disclose mattresses including foam springs or foam cells and materials/configurations therefor, adjustable bed assemblies including adjustable mattress frames, electrical, mechanical, and electronic components associated therewith, and remote controls for use therewith, all of which may be used individually or collectively in combination with the adjustable bed described herein.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### PARTS LIST

10 adjustable bed (including mattress support 100, adjustable frame 200, mattress 300, and magnet system 400)
20 adjustable foundation (including mattress support 100, adjustable frame 200, and deck magnetic material 410)
100 mattress support (or deck) surface
110 deck support (sections 110A-D as foot, leg, bottom, and back/head portions; longitudinally opposed ends 110A₁ and 110A₂, 110B₁ and 110B₂, 110C₁ and 110C₂, 110D₁ and 110D₂)
112 top surface of deck support (sections 112A-D as for deck support)
200 adjustable (bed) frame
210 frame support (sections 210A-D as for deck support)
220 support member
230 subframe
240 actuator or movement/articulation means
300 mattress (300A: foot end; 300D: head end)
305 containment frame
310 base
320 sidewalls
330 endwalls
340 foam cells or foam springs
400 magnet mattress alignment system
410 deck magnetic material
415 contact interface or surface
420 mattress magnetic material
422 pouch or sleeve
424 sleeve open area
426 sleeve base
X (local) lateral direction
Y (local) longitudinal direction
Z (local) normal direction
P pivot axis
Θ angle of articulation between adjacent sections

What is claimed is:

1. An adjustable bed comprising:
(a) a mattress support surface comprising (i) a first deck support section, and (ii) a second deck support section pivotally attached to the first deck support section;
(b) a mattress positioned above the mattress support surface;
(c) a first deck magnetic material disposed on an upper surface of the mattress support surface; and
(d) a first mattress magnetic material disposed on an outer bottom surface of the mattress and positioned in a complementary position relative to the first deck magnetic material;
wherein at least one of the first deck magnetic material and the first mattress magnetic material exerts a magnetic force attracting the complementary magnetic material.

2. The adjustable bed of claim 1, wherein the first deck magnetic material and the first mattress magnetic material are in contact with each other.

3. The adjustable bed of claim 1, wherein at least one of the first deck magnetic material and the first mattress magnetic material is at least partially enclosed in a sleeve mounted on at least one of the mattress support surface and the mattress, respectively.

4. The adjustable bed of claim 3, wherein the sleeve comprises an open area exposing its partially enclosed magnetic material to the opposing corresponding magnetic material or sleeve enclosing the opposing corresponding magnetic material.

5. The adjustable bed of claim 3, wherein the sleeve completely encloses its magnetic material.

6. The adjustable bed of claim 3, further comprising a high-friction material disposed on an outer surface of the sleeve and opposing the corresponding magnetic material.

7. The adjustable bed of claim 1, wherein the first deck magnetic material is at least partially enclosed in a first sleeve mounted on the mattress support surface, and the first mattress magnetic material is at least partially enclosed in a second sleeve mounted on the mattress.

8. The adjustable bed of claim 1, wherein the first deck magnetic material laterally extends a substantial portion of the mattress support surface width, and the first mattress magnetic material laterally extends a substantial portion of the mattress width.

9. The adjustable bed of claim 8, wherein the first deck magnetic material laterally extends at least 40% of the mattress support surface width, and the first mattress magnetic material laterally extends at least 40% of the mattress width.

10. The adjustable bed of claim 1, wherein
(i) the first deck magnetic material is disposed on an upper surface of the first deck section of the mattress support;
(ii) the first deck section corresponds to a foot portion of the mattress support surface and the mattress; and
(iii) deck support sections of the mattress support other than the first deck section are free from magnetic materials disposed thereon.

11. The adjustable bed of claim 1, wherein
(i) the first deck magnetic material is disposed on an upper surface of the first deck section of the mattress support;
(ii) the first deck section corresponds to a foot portion of the mattress support surface and the mattress; and
(iii) deck support sections of the mattress support corresponding to a head portion of the mattress support surface and the mattress are free from magnetic materials disposed thereon.

12. The adjustable bed of claim 1, wherein both of the first deck magnetic material and the first mattress magnetic material exert an attractive magnetic force toward each other.

13. The adjustable bed of claim 1, wherein the coefficient of static friction (μₛ) at a contact interface between the first deck magnetic material and the first mattress magnetic material is at least 0.5.

14. The adjustable bed of claim 1, wherein at least one of the first deck magnetic material and the first mattress magnetic material comprises a polymer material selected from the group consisting of a thermoset elastomer and a thermoplastic elastomer.

15. The adjustable bed of claim 1, wherein at least one of the first deck magnetic material and the first mattress magnetic material comprises a sheet magnet material.

16. The adjustable bed of claim 1, wherein both of the first deck magnetic material and the first mattress magnetic material comprises a sheet magnet material.

17. The adjustable bed of claim 1, wherein both of the first deck magnetic material and the first mattress magnetic material comprises an isotropic sheet magnet material.

18. The adjustable bed of claim 1, wherein the magnetic material exerting a magnetic force exerts at least 100 lb_{f} normal pulling force.

19. The adjustable bed of claim 1, wherein the mattress support surface further comprises (iii) a third deck support section pivotally attached to the second deck support section, and (iv) optionally a fourth deck support section pivotally attached to the third deck support section.

20. A method for adjusting an adjustable bed, the method comprising:
(a) providing the adjustable bed of claim 1; and
(b) articulating the adjustable bed from a first position to a second position, wherein:
(i) the mattress support surface in the second position is other than a flat configuration; and
(ii) the mattress remains substantially in contact with the mattress support surface in the first position and the second position.
